(19) United States
(12) Patent Application Publication
(10) Pub. No.: US 2007/0040137 A1
(43) Pub. Date: Feb. 22, 2007

(54) High-pressure inlet for a common rail injector

(76) Inventors: Giovanni Ferraro, Ludwigsburg (DE); Kasim-Melih Hamutcu, Remseck (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/574,659

(22) PCT Filed: Sep. 17, 2004
(86) PCT No.: PCT/DE04/02081

§ 371 Date: Apr. 4, 2006

(30) Foreign Application Priority Data
Oct. 6, 2003 (DE) 103 46 243.0

(51) Int. Cl. B05B 1/08; F16K 31/02

(52) U.S. Cl. 251/129.06; 239/102.2

(57) ABSTRACT

A valve for controlling fluids, having a valve housing which has an actuator chamber and at least two laterally located inlet bores that communicates with a high-pressure inlet, and the actuator chamber has an actuator with a ram and an actuator cap, and the actuator chamber has a conical seal, which is embodied by means of a conical face on the end of the actuator chamber and a corresponding annular sealing face on the actuator cap, and with the conical seal a cable outlet can be sealed off. A more-uniform introduction of force to the actuator is attained by the plurality of inlet bores.

### PRIOR ART

The invention relates to a valve for controlling fluids, having a valve housing, which has an actuator chamber and a laterally located inlet bore that communicates with a high-pressure inlet, and the actuator chamber has an actuator with a ram and an actuator cap, and the actuator chamber has a conical seal, which is embodied by means of a conical face on the end of the actuator chamber and a corresponding annular sealing face on the actuator cap, and with the conical seal a cable outlet can be sealed off.

Such valves are known from European Patent Disclosure EP 0 192 241. The injection valves, particular in common rail injection systems, are provided with servo valves for controlling the fluid flows. For supplying fuel to internal combustion engines, so-called storage injection systems are used, which work with very high injection pressures. Such injection systems are known as common rail systems for diesel engines and HPDI injection systems for Otto engines. In these injection systems, the fuel is pumped by a high-pressure pump into a common pressure reservoir, from which fuel is supplied to the injection valves at the individual cylinders. As a rule, the opening and closing of the injection valves are controlled electronically.

From German Patent Disclosure DE 196 50 865 A1, it is known that the fuel injector has a high-pressure connection that opens laterally into the injector body. Via a pressure bore, the quantity of fuel to be injected is delivered to the injection openings. Laterally on the injector body, a connection region is embodied, from which an inlet bore extends that supplies an actuator chamber with fuel that is under high pressure. A cable outlet likewise opens into this actuator chamber. So that no fuel will be able to flow out into this cable outlet, the cable outlet is sealed off via a conical seal. The requisite contact pressure of the actuator cap on the conical sealing face is achieved by means of the high pressure in the system.

A disadvantage of this known prior art is that because of this type of construction, there is an unfavorable force ratio at the bore intersection with the actuator chamber and between the conical sealing. Because of the unilateral bore and the extremely high pressures—typically up to 1600 bar—the actuator cap of the actuator can be subjected to a shear force and can become leaky. Moreover, high mechanical stresses can arise in this intersection region.

It is the object of the invention to create a valve of the type defined at the outset that prevents the aforementioned unfavorable force ratios and assures secure sealing.

### ADVANTAGES OF THE INVENTION

This object is attained in that the actuator chamber has at least one additional inlet bore, which enables a distribution of the introduction of force to the actuator cap and/or to the ram.

In an especially preferred embodiment, the inlet bores are located symmetrically about the longitudinal axis of the actuator. This has the advantage that the forces are introduced uniformly, which has a favorable effect on the sealing function of the conical seal and on the construction of the actuator.

In a preferred variant of the invention, the inlet bores discharge into the actuator chamber in the region of the conical face, outside the annular sealing face. This has the advantage that the forces can act on the actuator cap. Shear forces that otherwise act laterally on the ram of the actuator are thus largely avoided.

An especially economical variant provides that the high-pressure inlet is located centrally, along the center axis of the valve housing. The cost advantage is the result of the simplified production of the central bore.

In a preferred embodiment, the inlet bores extend at an acute angle to the center axis of the valve housing. This has the advantage that the injector wall thickness is increased by the acute-angle location of the inlet bores, and greater overall strength is obtained.

The overall strength can furthermore be increased by providing that the cross sections of the inlet bores are reduced compared to the cross section of an individual inlet bore. As a result, for the same fuel quantity and a higher number of inlet bores, there is a greater wall thickness of the individual inlet bores. Moreover, a throttling function can be achieved by means of the reduced cross section.

In a preferred embodiment, it is provided that a cross-sectional enlargement is located between the inlet bores and the high-pressure inlet. This cross-sectional enlargement forms a high-pressure chamber and reinforces a uniform distribution of the fuel quantity via the individual inlet bores.

An especially economical variant provides that the actuator is embodied as a piezoelectric actuator unit. Such piezoelectric actuators are simple to manipulate, inexpensive, and maintenance-free.

### DRAWING

The invention is described below in terms of an exemplary embodiment shown in the drawings.

FIG. 1, a schematic sectional view along the longitudinal axis showing a detail of a valve with a high-pressure inlet for a common rail injection system, in the prior art;

FIG. 2, a schematic sectional view showing the high-pressure inlet of the valve in an embodiment according to the invention;

FIG. 3, a schematic sectional view showing the high-pressure inlet of the valve in a further variant embodiment of the invention.

### DESCRIPTION OF EXEMPLARY EMBODIMENTS

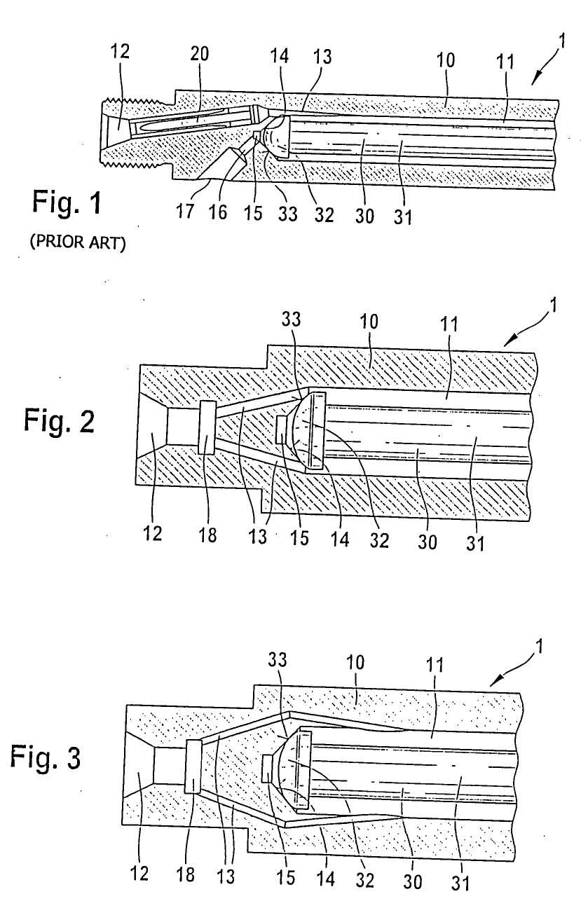

FIG. 1 shows a valve 1 for controlling fluids, in particular diesel fuel, which is part of a common rail injection system.

The valve 1 has a valve housing 10, in which a pressure bore extends longitudinally and forms an actuator chamber 11. An actuator 30 is supported in the actuator chamber 11 and has a ram 31 and an actuator cap 32. The actuator chamber 11 is sealed off on its end by means of a conical seal to a cable outlet 17. The conical seal is embodied by means of a conical face 14 on the end of the actuator chamber 11 and a corresponding annular sealing face 33 on the actuator cap 32.

The valve housing 10 furthermore has a high-pressure inlet 12, which is in communication with a high-pressure reservoir, not shown here, for liquid fuel. In the prior art, the fuel that is under high pressure is delivered laterally to the actuator chamber 11 of the valve housing 10 via an inlet bore 13. In addition, as shown in FIG. 1, filters 20 and/or inflow throttle elements may be provided between the high-pressure inlet 12 and the inlet bore 13. The inlet bore 13, extending obliquely to the longitudinal axis of the actuator chamber 11, opens laterally into the actuator chamber 11, which forms an annular hollow chamber around the ram 31 of the actuator 30. This hollow chamber is constantly filled with fuel, which is at extremely high pressure, typically 1600 bar and more.

The actuator 30 may be embodied as a piezoelectric actuator unit. The operative principle provides that by means of electrical voltage pulses, which are delivered to the actuator 30 via a cable, changes in length of the ram 31 of the actuator 30 cause a valve opening to be briefly opened; this opening is located (not shown in the drawing) on the end of the valve housing 10 diametrically opposite the conical face 14. As a result, the fuel can be injected into the combustion chamber of an internal combustion engine. The communication between the cable outlet 17 and the actuator 30 is implemented by means of a bore 16, which extends obliquely to the longitudinal axis of the valve housing 10 and which with a blind bore 15 forms an intersection region.

The sealing off of the actuator chamber 11 from the cable outlet 17 has special significance for the sake of malfunction-free operation. This is typically achieved by the high contact pressure of the actuator cap 32 against the conical face 14 because of the high pressure of the fluid. Because of the intersection of the inlet bore 13 with the actuator chamber 11, however, unfavorable force ratios can arise. Particularly because of the unilaterally provided inlet bore 13 in the prior art, shear forces can act on the actuator cap 32 and the ram 31 of the actuator 30, which in the conical seal can cause leaks and/or impermissibly high stresses in the actuator 30.

According to the invention, a construction is therefore proposed in which at least one further inlet bore 13 is provided. In an especially preferred embodiment, the inlet bores 13 are located symmetrically about the longitudinal axis of the actuator 30 and assure that the forces are introduced uniformly, which has a favorable effect on the sealing function of the conical seal and on the construction of the actuator 30.

FIG. 2 shows one of the preferred embodiments as an example.

The valve housing 10 has two diametrically opposed inlet bores 13, which discharge into the actuator chamber 11 in the region of the conical face 14, outside the annular sealing face 33 of the actuator cap 32. In this exemplary embodiment, the high-pressure inlet 12 is embodied centrally, along the center axis of the valve housing 10. As a result of this geometry, it can furthermore be achieved that the inlet bores 13 extend at an acute angle to the center axis of the valve housing 10. Moreover, as shown as an example in FIG. 2, a cross-sectional enlargement 18 may be provided, which is located between the high-pressure inlet 12 and the inlet bores 13. This cross-sectional enlargement 18 forms a high-pressure chamber and in the process reinforces a uniform distribution of the fuel quantity among the individual inlet bores 13. The cross sections of the inlet bores 13 may be reduced compared to the cross section of an individual inlet bore 13.

FIG. 3 shows a variant embodiment of the invention, in which the inlet bores 13, compared to the variant shown in FIG. 2, discharge laterally into the actuator chamber 11. Once again, the inlet bores 13 are located diametrically opposite one another, and hence a symmetrical introduction of force can result.

In principle, more than two inlet bores may also be provided, which are located symmetrically about the longitudinal axis of the actuator 30, preferably at equal angular intervals. Especially preferred exemplary embodiments have two inlet bores 13, which are located diametrically opposite with respect to the longitudinal axis of the actuator 30, or even three inlet bores 13, which are located at an angle of 120° with respect to the longitudinal axis of the actuator 30. By this means, a construction in particular which offers advantages in manufacture on the one hand and on the other avoids the disadvantages that can occur in arrangements according to the prior art is attained.

1-8. (canceled)

9. In a valve for controlling fluids, the valve having a valve housing which has an actuator chamber and a laterally located inlet bore that communicates with a high-pressure inlet, and the actuator chamber has an actuator with a die and an actuator cap, and the actuator chamber has a conical seal, which is embodied by means of a conical face on the end of the actuator chamber and a corresponding annular sealing face on the actuator cap, and with the conical seal a cable outlet can be sealed off, the improvement wherein the actuator chamber comprises at least one additional inlet bore.

10. The valve in accordance with claim 9, wherein the inlet bores are located symmetrically around the longitudinal axis of the actuator.

11. The valve in accordance with claim 9, wherein the inlet bores discharge into the actuator chamber in the region of the conical face, outside the annular sealing face.

12. The valve in accordance with claim 10, wherein the inlet bores discharge into the actuator chamber in the region of the conical face, outside the annular sealing face.

13. The valve in accordance with claim 9, wherein the high-pressure inlet is located centrally, along the center axis of the valve housing.

14. The valve in accordance with claim 10, wherein the high-pressure inlet is located centrally, along the center axis of the valve housing.

15. The valve in accordance with claim 11, wherein the high-pressure inlet is located centrally, along the center axis of the valve housing.

16. The valve in accordance with claim 9, wherein the inlet bores extend at an acute angle to the center axis of the valve housing.

17. The valve in accordance with claim 10, wherein the inlet bores extend at an acute angle to the center axis of the valve housing.

18. The valve in accordance with claim 11, wherein the inlet bores extend at an acute angle to the center axis of the valve housing.

19. The valve in accordance with claim 13, wherein the inlet bores extend at an acute angle to the center axis of the valve housing.

20. The valve in accordance with claim 9, wherein the cross sections of the inlet bores are reduced compared to the cross section of the inlet bore of a valve having only a single inlet bore.

21. The valve in accordance with claim 10, wherein the cross sections of the inlet bores are reduced compared to the cross section of the inlet bore of a valve having only a single inlet bore.

22. The valve in accordance with claim 11, wherein the cross sections of the inlet bores are reduced compared to the cross section of the inlet bore of a valve having only a single inlet bore.

23. The valve in accordance with claim 13, wherein the cross sections of the inlet bores are reduced compared to the cross section of the inlet bore of a valve having only a single inlet bore.

24. The valve in accordance with claim 9, further comprising a cross-sectional enlargement is located between the inlet bores and the high-pressure inlet.

25. The valve in accordance with claim 10, further comprising a cross-sectional enlargement is located between the inlet bores and the high-pressure inlet.

26. The valve in accordance with claim 11, further comprising a cross-sectional enlargement is located between the inlet bores and the high-pressure inlet.

27. The valve in accordance with claim 13, further comprising a cross-sectional enlargement is located between the inlet bores and the high-pressure inlet.

28. The valve in accordance with claim 9, wherein the actuator is embodied as a piezoelectric actuator unit.
